(19) United States
(12) Patent Application Publication
(10) Pub. No.: US 2017/0274592 A1
(43) Pub. Date: Sep. 28, 2017

(54) DEVICE AND METHOD FOR THE PRODUCTION OF THREE-DIMENSIONAL OBJECTS

(71) Applicant: CL SCHUTZRECHTSVERWALTUNGS GMBH, Lichtenfels (DE)

(72) Inventors: Frank HERZOG, Lichtenfels (DE); Florian BECHMANN, Lichtenfels (DE); Fabian ZEULNER, Lichtenfels (DE); Tobias BOKKES, Coburg (DE); Marie-Christin EBERT, Coburg (DE)

(73) Assignee: CL SCHUTZRECHTSVERWALTUNGS GMBH, Lichtenfels (DE)

(21) Appl. No.: 15/505,823

(22) PCT Filed: Aug. 18, 2015
(86) PCT No.: PCT/EP2015/068939

§ 371 Date: Feb. 22, 2017

(30) Foreign Application Priority Data
Aug. 22, 2014 (DE) 10 2014 012 286.7

(51) Int. Cl. B29C 67/00; B33Y 50/02

(52) U.S. Cl. CPC B29C 67/0077; B29C 67/0088; B33Y 50/02; B33Y 10/00

(57) ABSTRACT

The invention relates to a device for producing three-dimensional objects by successive solidification of layers of a construction material that can be solidified using radiation on the positions corresponding to the respective cross-section of the object, comprising a construction chamber in which a carrying device for carrying the object is arranged with a height adjustable carrier, a radiation device for radiating layers of the construction material at positions corresponding to the respective cross-section of the object, and an image acquisition device for acquiring at least one image data record representing the construction chamber, wherein in the construction chamber at least one position mark for calibrating the image acquisition device is present. In addition, the invention relates to a method for performing a calibration.

The invention relates to a device for producing three-dimensional objects by successive solidification of layers of a construction material that can be solidified using radiation on the positions corresponding to the respective cross-section of the object, comprising a construction chamber in which a carrying device for carrying the object having a height adjustable carrier is arranged, a radiation device for radiating layers of the construction material on the positions corresponding to the respective cross-section of the object, and an image acquisition device for acquiring at least one image data record representing the construction chamber.

When previously an image acquisition device is mentioned, this also comprises devices that use CMOS or CCD technology, i.e., devices in which an image is generated from individual pixel data. The term “image acquisition device” is therefore to be understood to also comprise such electronic devices.

Particulate processing methods are known in which a material is solidified in layers on predetermined positions to construct a three-dimensional object. Basically, liquids as in stereolithography or powders as in selective laser sintering (SLS) or selective laser melting (SLM) can be solidified. The already processed layers are lowered layer by layer, and a new layer is applied to solidify the construction material on the desired positions.

When applying material in layers, misplaced applications of material may occur. Furthermore, the different heating of construction material represents a problem, since the strength of the created three-dimensional object may be affected by this.

It is therefore further known to use a camera for monitoring the construction room or the construction chamber. EP 2 032 345 B1 teaches a device for selective laser powder processing in which the camera or photo diode assembly or CCD assembly is for solidifying the powder adjusted according to the laser beam.

It is further known to modify the irradiation energy or the dwell time of the laser by means of the image data such that the energy input per surface section is controlled. Thus, repeated melting of the same surface section can be avoided.

Despite all improvements, the problem is that the image data acquired by the camera or the data derived from it does not have the required accuracy, and in the prediction of derived data such as the temperature of the melting pool, i.e., the construction material melted on but not yet solidified again, has too large a tolerance.

Therefore, it is an object of the present application to indicate a device of the type mentioned at the beginning, in which the processing quality of the acquired image data is increased.

To solve this object, a device with the features according to claim 1 is suggested. Advantageous further developments result from the dependent claims.

As core of the invention it is considered that the image acquisition device can be calibrated by means of a position mark or position marks in the construction chamber. Namely, it turned out that the inaccuracies in the subsequent use of the image data of the image acquisition device are position-dependent and therefore there is a dependency of an information on the position within the image. Accordingly, this position-dependent measuring inaccuracy of the image acquisition device is compensated by calibration.

In the present application, calibration is thus obtaining information to that effect that measuring inaccuracies in image data records acquired during the construction process can be compensated. Said measuring inaccuracies are structure-dependent and cannot be eliminated by repositioning the image acquisition device.

Accordingly, the position mark is not intended to mark a certain position within the construction chamber, but marks a certain image position. By evaluating the image section representing the position mark, data for compensating the measuring inaccuracies can be obtained.

When calibrating, any value is to be used as a standard. Deviations from this standard are used to obtain one calibration datum or more calibration data. The standard may be the intensity value in the image center of an image data record acquired by the camera. Alternatively, it can be the lightest or the darkest intensity value of the image data record in the entire image or in an image section that can be predetermined. Further designs are described further below.

Between the image acquisition device and the construction chamber, a mirror assembly having at least one mirror can be arranged. Said mirror assembly serves to deflect the laser beam emitted by the laser device to solidify the construction material. Through said mirror assembly, also image data at least partially representing the construction chamber can be acquired.

Advantageously, the at least one position mark can be arranged on the bottom of the construction chamber or on a bottom plate on the bottom of the construction chamber. The position-dependent measuring inaccuracies relate to the layer of construction material that is lying in the construction plane, and is or is to be radiated with a laser beam. The construction plane is a plane parallel to the bottom and bottom plate. Thus, optimal calibration can be achieved with position marks spread on the bottom.

Preferably, a light-transmissive heat protection device, especially made of glass ceramic, can be arranged above the position mark. If the position marks are sensitive to heat, they are protected by the glass ceramic layer, since said layer shields the position marks from the heat energy entered by the laser beam and passed on via the construction material.

It is preferably provided that the position marks simulate equal radiation characteristics of the construction material used in the construction chamber in at least some sections or at certain points of support. Thus, it is pretended that the construction material has a given heat radiation that is constant in the entire construction plane. The electromagnetic radiation emitted is simulated by the position marks. In the extreme case, the position mark is an illuminating device illuminating all or part of the bottom or the bottom plate.

To implement the position marks in a cost-efficient way, they can be designed as LED lamps. These preferably emit light in visible and infrared wavelength ranges from 700 nm to 1100 nm, especially at a wavelength between 800 nm and 900 nm. This is the wavelength or the wavelength range that is also emitted by the heated construction material. By simulating the radiation of the construction material at idealized conditions, especially related to the temperature considered constant, it can be achieved that deviations in the illustration of an image section of the image data record illustrating the position mark or position marks from another image section can only be explained by the position-dependent measuring inaccuracies of the image acquisition device, whereby they can be corrected.

Basically, it does not matter if the homogeneous emission of light over a section of the bottom or the bottom plate is implemented with a single position mark or with a plurality of position marks. However, it is preferred to provide a plurality of position marks. This provides the advantage that, in the event of failure of a position mark, calibrating the image acquisition device is still possible. Then, it is preferred that the position marks each have a given light emission angle that is especially parallel. The image acquisition device then represents parallel light beams, whereby position-dependent measuring inaccuracies can be determined and corrected in an especially simple manner.

When using a plurality of position marks, the position marks form points of supports. Intermediate sections can be interpolated.

An image data record representing at least one position mark is thus used to obtain at least one calibration information or one calibration datum. This happens prior to a construction process. Using the calibration data, during a construction process the image data records representing the construction plane within the construction chamber are corrected such that the data derived therefrom, such as temperature data of the position-dependent measuring inaccuracies, are revised.

The device for producing three-dimensional objects is preferably a laser melting device or a laser sintering device.

The image acquisition device is preferably designed as a photo-camera or camera. Thus, it can acquire individual images or image data records, respectively, or consecutive image data records. The image acquisition device is preferably designed for acquiring in the range of visible light or infrared light.

In addition, the invention relates to a method for producing a three-dimensional component by an additive construction method in which the component is constructed by successive solidification of determined sections of individual layers as a result of the impact of a radiation source onto the construction material that can be solidified, wherein the sections are solidified in single portions spaced apart, and wherein an image acquisition device for acquiring at least one image data record of the construction chamber receiving the construction material is provided. This is characterized in that, using the image acquisition device, at least one image data record is acquired as a reference image data record with at least one light emitting position mark, and by means of the at least one reference image data record a correction of an image data record acquired during a construction process is performed.

Further advantages, features, and details result from the figures and exemplary embodiments described below. In which:

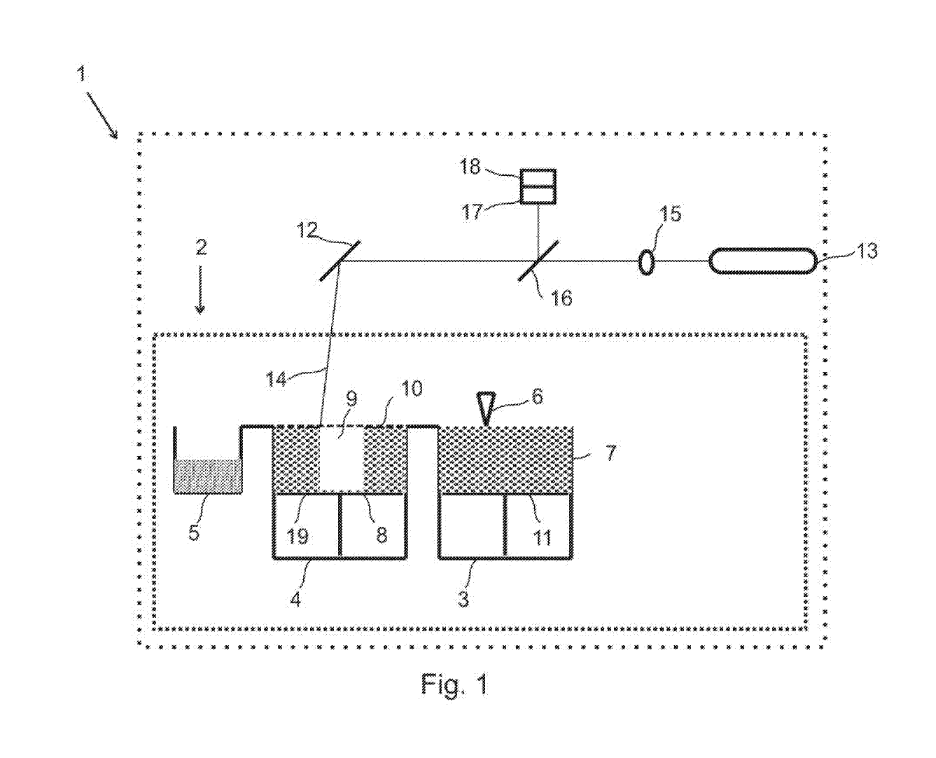

FIG. 1 shows a device for producing three-dimensional objects;

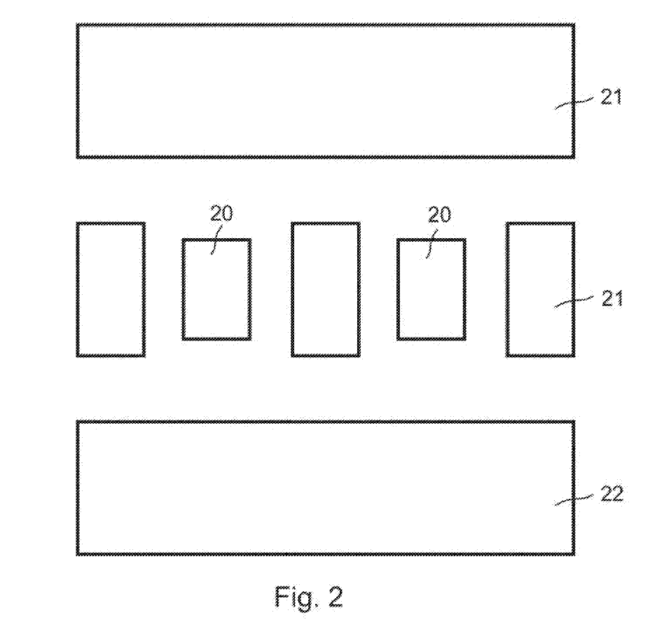

FIG. 2 shows the structure in the bottom section of the construction chamber in cross-section;

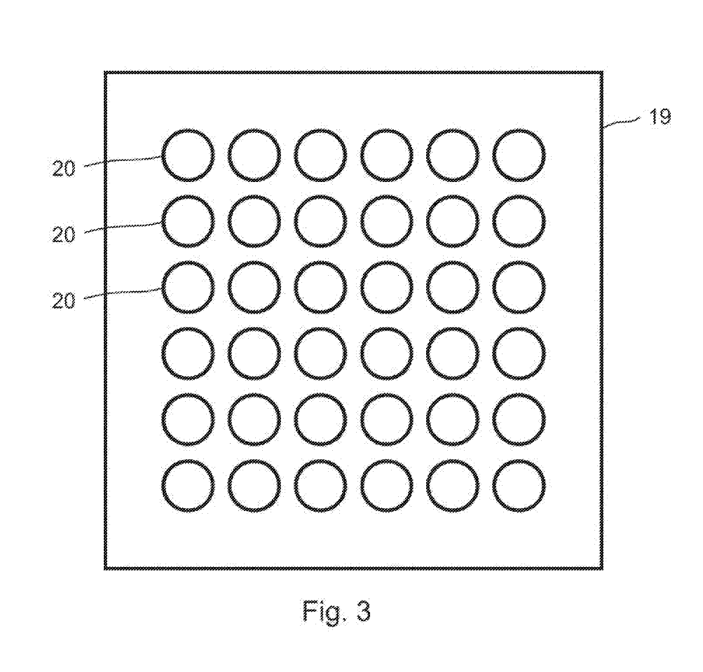

FIG. 3 shows position marks of a first design;

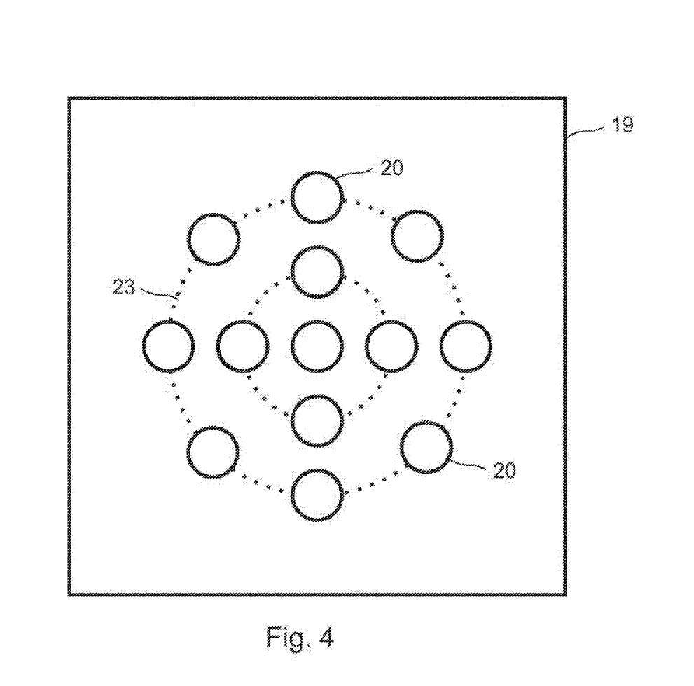

FIG. 4 shows position marks of a second design;

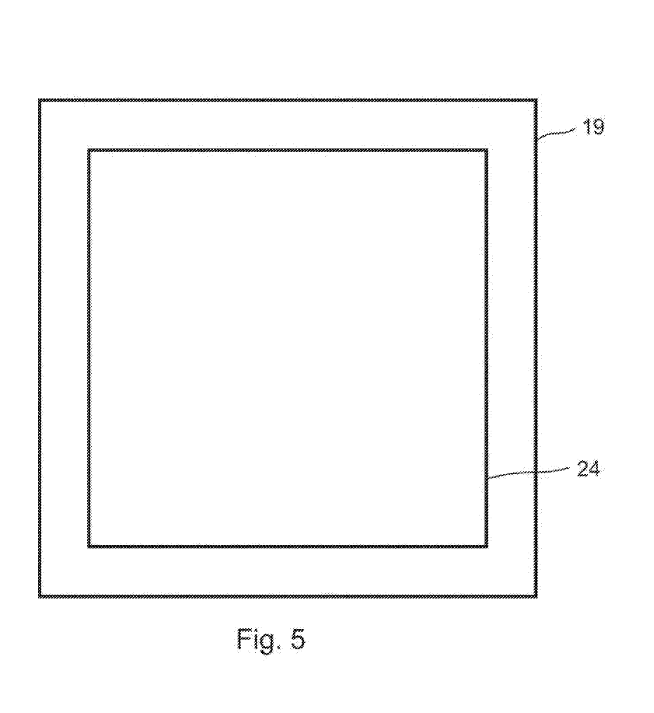

FIG. 5 shows position marks of a third design;

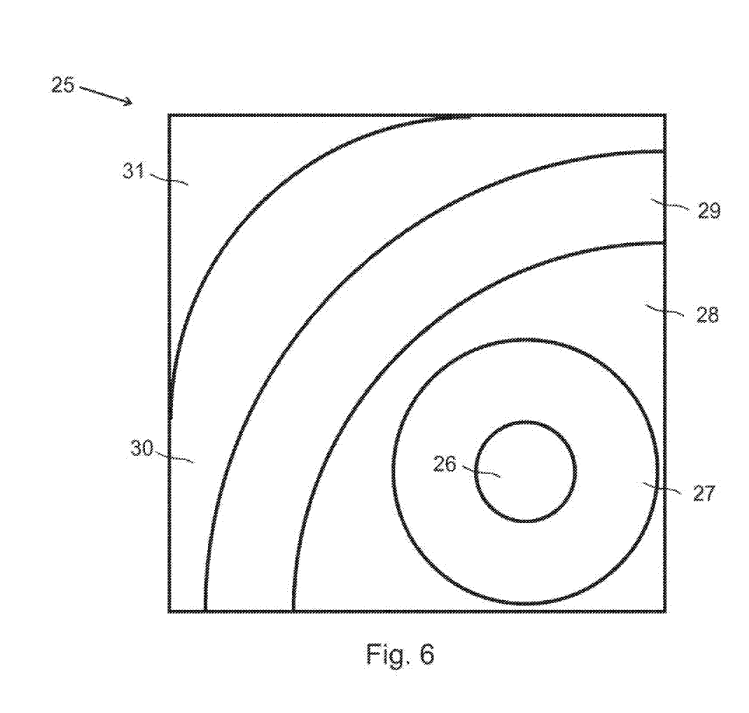

FIG. 6 shows a calibration data record; and

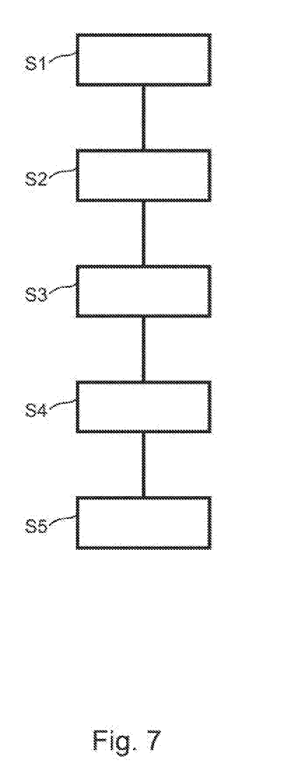

FIG. 7 shows a timing chart for performing a calibration.

FIG. 1 shows a device 1 for producing three-dimensional objects by successive solidification of layers of a powder-type construction material that can be solidified. Any elements not significant for the invention, such as, for example, the gas supply for the supply of inert gas, which is always to be provided, are not explicitly indicated in the figures. Shown is a construction module 2 with a metering chamber 3, a construction chamber 4, and an overflow chamber 5. Above the metering chamber 3 and the construction chamber 4, an application device 6 for transporting construction material 7 from the metering chamber 3 to the construction chamber 4 can be moved. The construction material is a powder-type material consisting of metal or plastic that can be solidified.

In the construction chamber 4, a carrying device 8 is located. By means of the carrying device 8, the three-dimensional object 9 can be adjusted in height. The respective topmost layer of the construction material 7 in the construction chamber 4 forms the construction plane 10. The construction material 7 in the construction plane 10 is solidified on the corresponding positions using laser radiation. Once a layer of construction material 7 in the construction chamber 4 is solidified on the desired positions, the carrying device 8 is lowered and a new layer of construction material 7 is transported using the application device 6 from the metering chamber 3 to the construction chamber 4. For lifting the construction material 7 in the metering chamber 3, said chamber also has a carrying device 11.

Above the construction module, a mirror assembly 12 is positioned by means of which the laser beam 14 emitted from a laser beam device 13 can be deflected such that the respective desired sections of the construction plane 10 are irradiated. In the optical path of laser beam 14, a lens assembly 15 and a beam splitter 16 are further located. By means of the lens assembly 15, the laser beam 14 is focused, whereas the beam splitter 16 is, on the one hand, permeable to laser beam 14 and, on the other hand, deflects the light towards the camera 17 as an image acquisition device. Thus, the camera 17 can image the construction plane 10.

The camera 17 is connected to a control device 18. This can be a control device 18 assigned to the camera 17, but it can also be the control device 18 of the device 1 performing a plurality of control tasks and, for example, controlling the laser beam device 13 and/or the mirror assembly 12.

The mirror assembly 12 and the lens assembly 15 can each contain one or more mirrors or lenses.

On the carrying device 8 of the construction chamber 4 forming the bottom of the construction chamber 4, a bottom plate 19 is located. There are recesses within the bottom plate 19 in which LED lamps 20 are arranged as position marks. On the bottom plate 19, yet a glass ceramic plate 21 is arranged as heat protection for the LED lamps 20. When constructing the first layers, a large amount of heat is emitted by the laser beam 14 towards the LED lamps 20. The glass ceramic plate 21 shields the LED lamps 20 from that.

FIG. 2 shows a cross-section of the structure on the bottom of the construction chamber 2. In said cross-section, the carrier 22 of the carrying device 8, the bottom plate 19 with the LED lamps 20 arranged therein, and the glass ceramic plate 21 are shown. The electric connection of LED lamps 20 is not shown. This can, for example, run through the carrier 22.

The spindle drive of the carrying device 8, lifting and lowering the carrier 22, is not shown either.

FIG. 3 shows a top view of a bottom plate 19 for clarification of a possible distribution of the LED lamps 20. Said distribution and the distributions shown in the FIGS. 4 and 5 are suited for all types of position marks, not only for LED lamps 20.

FIG. 3 shows a grid structure of the LED lamps 20. In the design shown, the center points of the LED lamps 20, only three of which are exemplarily depicted with reference numbers for the sake of clarity, each have the same distance; furthermore, the connecting lines of the grid are rectangular. Alternatively, it is possible to also use other grid structures such as diamond patterns, etc.

FIG. 4 shows another alternative arrangement of the LED lamps 20. They are arranged on concentric circles 23. Said circles 23 are shown in dashed lines and are only intended for orientation. The LED lamps 20, only some of which are in turn depicted with reference numbers, are represented by circles having a continuous line. The distance of the circles is determined, among other things, by the LED lamp size, the number to be achieved per area, the required wall thickness of the bottom plate 19 between the LED lamps 20, etc.

The LED lamps 20 can be arranged as if lined up on spokes, as shown, wherein the number of spokes is increasing with the circle diameter increasing. The LED lamps 20 can also be arranged relatively arbitrarily on the circles 23.

When calibrating, any value is to be used as a standard, as described in the beginning. This can be the intensity value of the LED lamp 20 in the image center of an image data record acquired by the camera 17. Alternatively, it can be the lightest or the darkest intensity value of an LED lamp 20 or a position mark in the entire image or in an image section that can be predetermined. The selection of the standard depends on the general conditions and may deviate from the suggested designs.

FIG. 5 shows another design of a position mark as a planar lighting device 24. Preferably, the light emission of the lighting device 24 is homogeneous across the entire surface, but in the end it is sufficient that the distribution of the light emission is known. This is then to be considered for calibration of the camera 17.

The lighting device 24 can, for example, be obtained by a light distributing plate being present above the LED lamp 20 in a structure as in FIG. 3. Said plate is preferably employed below a glass ceramic plate 21.

The light emission of the LED lamps 20 or the lighting device 24 is acquired prior to the beginning of the construction by the camera 17 in at least one image data record. Based on this image data record and independent from the design of the position marks, at least one calibration datum is obtained, wherein a datum is herein to be understood as the singular of “data”, meaning information especially in the form of numerics or numbers.

Preferably, a calibration data record 25 is determined from an image data record representing the light emission of the position marks, especially of the LED lamps 20 or the lighting device 24, by generating a standard value from an image element, also called pixel, or an image section by averaging over several image elements. Then, all further image points are divided by said standard value, and the inverse thereof is taken. This is carried out image element by image element or pixel by pixel. A calibration data record 25 is shown in FIG. 6.

Since these values are “polluted” with noise, in the calibration data record 25 sections 26, 27, 28, 29, 30, and 31 can be found that differ by noise only. In these sections 26, 27, 28, 29, 30, and 31, an average value can be generated each to suppress or reduce the noise.

After the generation of the calibration data record 25, this is simply multiplied pixel by pixel by the image data records acquired during the construction of the three-dimensional object 9 to eliminate the position-dependent measuring inaccuracies.

From FIG. 6 it also follows that the measuring inaccuracies need not occur symmetrically around the image center. With the device and the method described, it is rather possible to eliminate any measuring inaccuracies.

FIG. 7 shows a timing chart for performing a calibration of an image acquisition device, thus the camera 17.

In step S1, a bottom plate 19 with LED lamps 20 is placed on the carrier 22 in a construction chamber 4, and an electric connection to the LED lamps is established. Preferably, respective contacts are present on the carrier 22 such that simple placement is sufficient.

In step S2, the carrier 8 is moved to a height such that the lamps lie and emit light on that height on which the construction plane 10 will later be lying.

In the following step S3, an image data record is acquired by the camera 17. From said record, a calibration data record 25 is determined in step S4. Any commonly used and described process steps such as consideration of the distribution of the light emission of the LED lamps 20 or the lighting device 24, averaging, selection of standards, etc. can be used. For calculation, the control device 18 is used.

The calibration data record 25 is then stored as step S5 in a storage device not shown.

Said calibration and generation of a calibration data record 25 can be carried out prior to each construction process. However, it can also be carried out only once for putting the camera 17 into operation. In particular, LED lamps 20 with different wavelength emissions can be used to generate a calibration data record associated with each construction material 7. The LED lamps with different wavelength emissions can also be arranged on a bottom plate 19 and be separately actuated. Alternatively, a separate bottom plate 19 or a separate bottom for each given wavelength or each wavelength range can be provided. The distribution of the LED lamps 20 and the generation of calibration data or data records are independent from each other.

### LIST OF REFERENCE NUMBERS

1 Device
2 Construction module
3 Metering chamber
4 Construction chamber
5 Overflow chamber
6 Application device
7 Construction material
8 Carrying device
9 Three-dimensional object
10 Construction plane
11 Carrying device
12 Mirror assembly
13 Laser beam device
14 Laser beam
15 Lens assembly
16 Beam splitter
17 Camera
18 Control device
19 Bottom plate
20 LED lamp
21 Glass ceramic plate
22 Carrier
23 Circle
24 Lighting device
25 Calibration data record
26 Section
27 Section
28 Section
29 Section
30 Section
31 Section

1. A device (1) for producing three-dimensional objects (9) by successive solidification of layers of a construction material (7) that can be solidified using radiation on the positions corresponding to the respective cross-section of the object (9), comprising a construction chamber (4) in which a carrying device (8) for carrying the object (9) is arranged with a height adjustable carrier (22), a radiation device (13) for radiating layers of the construction material (7) on the positions corresponding to the respective cross-section of the object, and an image acquisition device (17) for acquiring at least one image data record representing a portion of the construction chamber or the whole construction chamber,
characterized in that
in the construction chamber (4) at least one position mark (20, 24) for the calibration of the image acquisition device (17) is present.

2. A device according to claim 1,
characterized in that
at least one position mark (20, 24) is arranged on the bottom of the construction chamber (4).

3. A device according to claim 1,
characterized in that
at least one position mark (20, 24) is arranged on a bottom plate (19) on the bottom of the construction chamber (4).

4. A device according to one of the preceding claims,
characterized in that
above the position mark (20, 24) a light-transmissive heat protection device (21), especially made of glass ceramic, is arranged.

5. A device according to one of the preceding claims,
characterized in that
the at least one position mark is designed as an LED lamp (20).

6. A device according to one of the preceding claims,
characterized in that
the position mark (20, 24) emits light in visible and infrared wavelength ranges.

7. A device according to claim 6,
characterized in that
the position mark (20, 24) emits light of a wavelength in the range between 800 nm and 900 nm.

8. A device according to one of the preceding claims,
characterized in that
a plurality of position marks (20) is provided, each of which has a given light emitting angle.

9. A device according to claim 8,
characterized in that
the position marks (20) essentially have parallel main emitting directions.

10. A device according to one of claim 8 or 9,
characterized in that
the position marks (20, 24) essentially emit towards a mirror assembly above the construction chamber.

11. A device according to one of the preceding claims,
characterized in that
at least one image data record acquired using the image acquisition device (17) can be changed using at least one calibration data record (25).

12. A device according to one of the preceding claims,
characterized in that
at least one image data record acquired using the image acquisition device (17) can be changed using at least one image data record having several light signals of LED lamps (20).

13. A device according to one of the preceding claims,
characterized in that
at least one image data record acquired using the image acquisition device (17) can be used to determine a calibration data record (25).

14. A device according to one of the preceding claims,
characterized in that
the device (1) has a storage to store a calibration data record.

15. A method for producing a three-dimensional object (9) by an additive construction method in which the object (9) is carried out by successive solidification of determined sections of individual layers as the result of the impact of a radiation source (13) onto the construction material (7) that can be solidified, wherein the sections are solidified in single portions spaced apart, and wherein an image acquisition device (17) is provided for acquiring at least one image data record of the construction chamber (4) receiving the construction material (17),
characterized in that
using the image acquisition device (4) at least one image data record is acquired as reference image data record with at least one light emitting position mark (20, 24), and using the at least one reference image data record at least one calibration datum, especially a calibration data record (25) for correcting an image data record recorded during a construction process, is determined.

16. A method according to claim 15,
characterized in that
a light emitting position mark (20, 24) is used that emits light at a wavelength or in a wavelength range corresponding to the wavelength or wavelength range that the construction material (7) used for constructing emits.

17. A method according to one of claim 15 or 16,
characterized in that
light in visible and infrared wavelength ranges is emitted.

18. A method according to one of claims 15 to 17,
characterized in that
an LED lamp (20) is used as position mark.
